(19) United States
(12) Patent Application Publication
(10) Pub. No.: US 2026/0010800 A1
(43) Pub. Date: Jan. 8, 2026

(54) A COMPUTER-IMPLEMENTED METHOD AND AN APPARATUS FOR DEEP LEARNING

(71) Applicants: Robert Bosch GmbH, Stuttgart (DE); TSINGHUA UNIVERSITY, Beijing (CN)

(72) Inventors: Gao Huang, Beijing (CN); Haojun Jiang, Beijing (CN); Jiangwei Yu, Beijing (CN); Shiji Song, Beijing (CN); Yulin Wang, Beijing (CN); Zanlin Ni, Beijing (CN); Kaixuan Zhang, Shanghai (CN)

(21) Appl. No.: 18/993,301

(22) PCT Filed: Aug. 11, 2022
(86) PCT No.: PCT/CN2022/111726

§ 371 Date: Jan. 10, 2025

(51) Int. Cl. G06N 3/0985

(52) U.S. Cl. CPC G06N 3/0985

(57) ABSTRACT

A computer-implemented method for deep learning including obtaining a meta network including of a set of incubating modules. Each of the set includes at least one basic unit of an architecture of a deep learning network. The meta network is pre-trained on a dataset. The method includes independently training, on the dataset, a set of modules with each of the set of modules corresponding to a respective one of the set of incubating modules, with one of the set of incubating modules being substituted by one of the set of modules corresponding to the one of the set of incubating modules on the dataset for training of the one of the set of modules, wherein each module of the set includes basic unit(s) of the architecture of the deep learning network; assembling the independently trained modules; and obtaining the deep learning network that is optimized on the dataset.

### FIELD

Aspects of the present invention relate generally to artificial intelligence, and more particularly, to a method and an apparatus for deep learning.

### BACKGROUND INFORMATION

Recent years has seen a rapid increase in the use of deep learning models, with researchers and practitioners applying these models to bring great effects across a wide range of applications, such as image and video classification, image and speech recognition, and language translation, etc. As deep learning models have become more widely developed and used, model sizes have grown to a new level (e.g., tens to hundreds of layers, totally 10-20 million parameters, or even tens of thousands of layers), in order to increase effectiveness, for example.

Training such large models is not a trivial task and generally facing two major challenges: 1) On infrastructure side, large models impose greater requirements on computational resources. Extremely large models can only be trained on highly optimized clusters with strong computation, memory, and communication capacities. 2) On optimization side, large models also require sophisticated design of optimization algorithms, weight initializations and other techniques in order to avoid optimization issues.

Modularized training, where a model is divided into several modules with each module being trained individually, can be a good solution to both the challenges. However, training deep models in a modularized way also faces a problem of a contradiction between independency and compatibility: The modules need to be trained independently, but they also need to be compatible with each other when being used as a whole model.

Consequently, it may be desirable to provide an improved technique for modularized training of large models in consideration of both independency and compatibility of the modules.

### SUMMARY

The following presents a simplified summary of one or more aspects according to the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present invention, a computer-implemented method for deep learning is provided. According to an example embodiment of the present invention, the method comprises: obtaining a meta network consisting of a set of incubating modules, wherein each of the set of incubating modules comprises at least one basic unit of an architecture of a deep learning network, and the meta network is pre-trained on a dataset; independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network; assembling the independently trained modules of the set of modules to form an assembled model; and obtaining, based at least in part on the assembled model, the deep learning network that is optimized on the dataset.

In another aspect of the present invention, a computer-implemented method of deep learning for a task is provided, the method comprises: obtaining a meta network consisting of a set of incubating modules, wherein each of the set of incubating modules comprises at least one basic unit of an architecture of a deep learning network for the task comprising image or speech recognition, and the meta network is pre-trained on a dataset comprising images or speech signals; independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network; assembling the independently trained modules of the set of modules to form an assembled model; and obtaining, based at least in part on the assembled model, the deep learning network that is optimized on the dataset.

In another aspect of the present invention, an apparatus for deep learning is provided, the apparatus comprises a memory and at least one processor coupled to the memory and configured for obtaining a meta network consisting of a set of incubating modules, wherein each of the set of incubating modules comprises at least one basic unit of an architecture of a deep learning network, and the meta network is pre-trained on a dataset; independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network; assembling the independently trained modules of the set of modules to form an assembled model; and obtaining, based at least in part on the assembled model, the deep learning network that is optimized on the dataset.

In another aspect of the present invention, a computer program product for deep learning is provided. According to an example embodiment of the present invention, the computer program product comprises processor executable computer code for obtaining a meta network consisting of a set of incubating modules, wherein each of the set of incubating modules comprises at least one basic unit of an architecture of a deep learning network, and the meta network is pre-trained on a dataset; independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network; assembling the independently trained modules of the set of modules to form an assembled model; and obtaining, based at least in part on the assembled model, the deep learning network that is optimized on the dataset.

In another aspect of the present invention, a computer readable medium storing computer code for deep learning is provided. According to an example embodiment of the present invention, the computer code when executed by a processor, causes the processor to perform operations comprising: obtaining a meta network consisting of a set of incubating modules, wherein each of the set of incubating modules comprises at least one basic unit of an architecture of a deep learning network, and the meta network is pre-trained on a dataset; independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network; assembling the independently trained modules of the set of modules to form an assembled model; and obtaining, based at least in part on the assembled model, the deep learning network that is optimized on the dataset.

By using a pre-trained lightweight meta network to incubate modules divided from a deep network, a decoupled or independently training process may be achieved while ensuring the compatibility.

Other aspects or variations of the present invention, as well as other advantages thereof will become apparent by consideration of the following detailed description and accompanying drawings.

### BRIEF DESCRIPTION OF THE DRAWINGS

The disclosed aspects of the present invention will hereinafter be described in connection with the figures that are provided to illustrate and not to limit the disclosed aspects.

FIG. 1 illustrates a schematic diagram of an exemplary solution for a firstly training phase of a two-phase modularized learning framework, according to an example embodiment of the present invention.

FIG. 2 is a chart illustrating the performance of the assembled model after the exemplary solution for the firstly training phase with and without fine-tuning, according to an example embodiment of the present invention.

FIG. 3 illustrates a comparison between each module's output feature in the assembled model with greedy implementation and in the E2E trained model using Centered Kernel Alignment (CKA) similarity, according to an example embodiment of the present invention.

20 FIG. 4 illustrates the CKA similarity between the input of module at the end of the modularized training phase and the input of module at the start of the assembly fine-tuning phase, according to an example embodiment of the present invention.

FIG. 5 illustrates an example schematic diagram of a process for modularized training using a meta network, according to one or more aspects of the present invention.

FIG. 6 illustrates an example of module reusing, according to one or more aspects of the present invention.

FIG. 7 illustrates an exemplar workflow of a method for modularized training using a meta network to obtain a deep learning network, according to one or more aspects of the present invention.

FIG. 8 illustrates an exemplar workflow of a method for module reusing, according to one or more aspects of the present invention.

FIG. 9A and FIG. 9B illustrate an experimental performance of the proposed methods and/or the process with freezing the meta network during the decoupled training phase, according to one or more aspects of the present invention.

FIG. 10 illustrates an example of a hardware implementation for an apparatus according to one or more aspects of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

Supervised end-to-end (E2E) learning may be a standard approach to neural network optimization. However, when training large models, E2E learning approaches may face challenges on both infrastructure side and optimization side. For example, on the infrastructure side, large models impose greater requirements on computation resources. Extremely large models can only be trained on highly optimized computation clusters with strong computation, memory, and communication capacities. For another example, on the optimization side, large models require sophisticated design of optimization algorithms, weight initializations and other techniques, in order to avoid optimization issues.

As an example, a conventional way to train a large model may be to add more computational power (e.g., more GPU nodes) and train network using data-parallel Stochastic Gradient Descent, where each worker receives a portion of a global (mini-)batch, e.g., a chunk of the global (mini-)batch. The size of a chunk should be large enough to sufficiently use the computational resources of the worker. Therefore, scaling up the number of workers results in an increase of batch size. However, using large batch may negatively impact accuracy of the model. To maintain the network accuracy, it is necessary to carefully adjust training hyper-parameters (e.g., learning rate, momentum, etc.).

Modularized training, where a model is divided into several modules with each module being trained independently, can be a good solution to training large models. However, modularized training needs both independency and compatibility of the divided modules to solve the challenges on training larges models. That is, the modules need to be trained independently, but they also need to be compatible with each other in order to perform properly when being used as a whole model. However, there is an apparent contradiction between the requirements of independency and compatibility.

Existing alternatives to E2E may be seen as weakly modularized training methods, where these methods only achieve incomplete independency to preserve compatibility. For example, delayed gradient-based methods and synthetic gradient-based methods make approximations to E2E training, in order to reserve some level of cross-module compatibility. Local learning-based methods implement weakened coupling between modules by introducing auxiliary networks. However, all these methods still need cross-module communication, especially during forward-propagation. Therefore, the requirement of independency is not fully realized, which in turn may prevent modularized training from achieving its full potentials.

Generally, a large model may be split into several modules, and these modules may be spread over a plurality of devices or nodes for training. However, communication between these modules over the plurality of devices or nodes due to a sequential nature of forward-propagation and back-propagation algorithm may cause low resource utilization, which can significantly lower the training process. In particular, larger communication overhead is induced as more devices are used.

As an example, consider a model M which is divided into K modules: M=M_{K}·M_{K-1}· . . . · M₁. The input and output spaces of module Mᵢ are denoted as [symbol] ᵢ₋₁ and [symbol] ᵢ. In the E2E training, a module Mᵢ is trained by first forwarding the input signal hᵢ₋₁∈ [symbol] ᵢ₋₁ to produce the output hᵢ=Mᵢ(hᵢ₋₁), and then back-propagating the error signal δᵢ∈ [symbol] ᵢ to update the model parameters Δθᵢ=δᵢΔ_{θi}hᵢ, where the input signal and the error signal are respectively given as:

$${h}_{i - 1} = {M}_{i - 1} ∘ … ∘ {M}_{1} ( x ) , {δ}_{i} = {∇}_{{h}_{i}} L ( {M}_{K} ∘ … ∘ {M}_{i + 1} ( {h}_{i} ) , y ) \qquad Formulation ( 1 )$$

Therefore, E2E training ensures the compatibility by the strong dependency of both the input signal on preceding modules and the error signal on subsequent modules. However, this also makes it impossible to achieve independency (e.g., without any cross-module communication) during the training process of a given module. In other words, the two requirements of independency and compatibility are actually in conflict with each other.

To this end, the present disclosure provides a method for modularized training using a meta network to obtain a deep learning network, where modules are trained in a fully decoupled way without any communication between the modules while some level of compatibility is injected into the modules even when they are trained in a fully decoupled way, according to one or more aspects of the present disclosure. The proposed method can avoid inducing any communication overhead while ensuring the compatibility. Thus, it can reduce the burden on GPU memory and computational capacity, and can also open new possibilities in highly heterogeneous scenarios where different devices have highly different communication capabilities. Furthermore, since the proposed method removes the cross-module dependency on other modules, usage efficiency of computational resources may be improved, and effectiveness of parallel computation may be maximized accordingly. Also, such a divide-and-conquer strategy through the fully decoupled way may less likely to incur optimization issues. The proposed method may be applicable to a variety of deep neural networks or graph neural networks for a variety of tasks, which may comprise, but not limited to, image or speech recognition, or image classification, or recommendation, and the like.

In general, training each module in a fully independent way may cause an issue of compatibility. For example, in a two-phase modularized learning framework, modules (e.g., Mᵢ, i=1 . . . K) are firstly trained in a fully decoupled way, and then the trained modules (e.g.,

$${M}_{i}^{*} ,$$

i=1 . . . K) are assembled together to form a whole model

$${M}^{assm} = {M}_{K}^{*} ∘ {M}_{K - 1}^{*} ∘ … ∘ {M}_{1}^{*} ,$$

and M^{assm} is then fine-tuned to facilitate cross-module compatibility to obtain the final model M*. In the second phase of assembly fine-tuning, module compatibility is facilitated by enabling the cross-module communication.

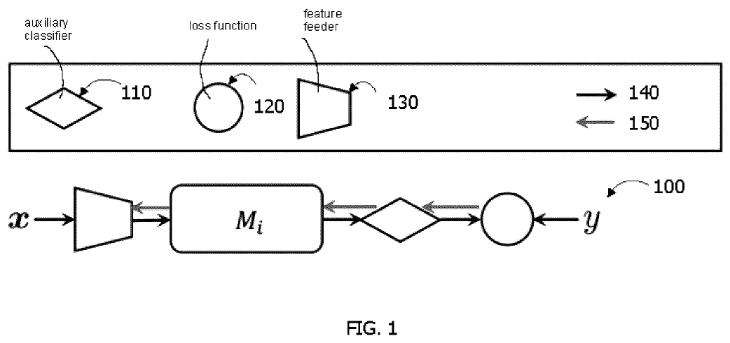

FIG. 1 illustrates a schematic diagram of an exemplary solution for a firstly training phase 100 of a two-phase modularized learning framework. In the firstly training phase 100, preceding modules for a module Mᵢ may be greedily replaced by a simple feature feeder 130 that transforms input x to a correct feature space for the module Mᵢ, and subsequent modules for the module Mᵢ may be replaced by an auxiliary classifier 110, which passes output to a loss function 120 to compare with a correct result y. Arrow 140 may represent a forward-propagation, and arrow 150 may represent a back-propagation during the training of the module Mᵢ. By using the firstly training phase 100, each of the divided modules may be trained independently.

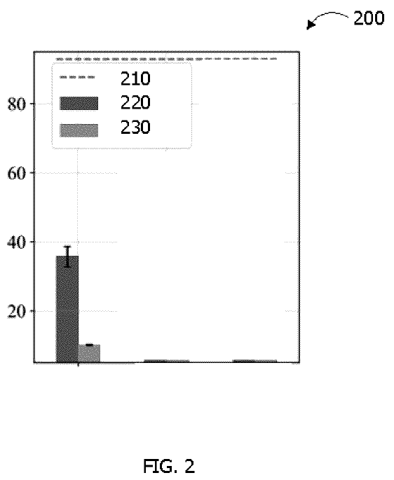

The performance of the assembled model after the firstly training phase 100 with and without fine-tuning is shown in chart 200 of FIG. 2. The vertical axis of chart 200 denotes the test accuracy in percentage, and dotted line 210 denotes a testing on E2E, which is also presented as an upper bound. Stripe 230 denotes a testing on the assembled model without fine-tuning, and as shown with a low accuracy much less than 20%, it produces no better results than random guessing since no compatibility is guaranteed at all during the firstly training phase 100. However, fine-tuning the assembled model, as denoted by stripe 220, still does not provide much gain, and there is a large gap between the fine-tuned model M* and the E2E trained counterpart M^{E2E}, as denoted by dotted line 210. This may indicate that the greedy implementation of two-phase modularized learning framework poses too much burden on the assembly fine-tuning phase, which makes it impractical to recover the compatibility by using an assembly fine-tuning phase.

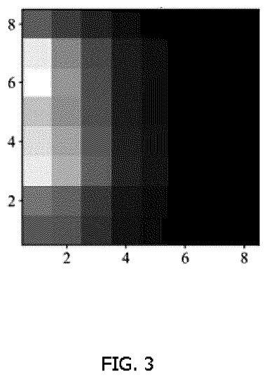

Accordingly, the proposed method pre-injects some level of compatibility even when the modules are being trained fully independently to alleviate the burden. To better achieve the compatibility, the incompatibility shown in FIG. 2 may be firstly analyzed. The reasons of the incompatibility may lie in feature level mismatch in early modules and input distribution shift in later modules. FIG. 3 illustrates comparison between each module's output feature in the assembled model M^{assm} with greedy implementation and in the E2E trained model M^{E2E} using Centered Kernel Alignment (CKA) similarity, where the comparison is conducted using a ResNet-110 with K=8 on CIFAR-10 dataset. In FIG. 3, modules in the assembled model M^{assm} with greedy implementation are successively represented along horizontal axis, and modules in E2E trained model M^{E2E} are successively represented along vertical axis. As shown in FIG. 3, the early modules in M^{assm} produce features that are similar to the features produced by later modules in M^{E2E}. This may result from the short-sight nature of the greedy approach, where the modules are trained to produce features that are most suitable for a classifier. However, in an assembled model, later modules are generally expecting early modules to capture low-level fine-grained feature for further processing. Therefore, the incompatibility is caused.

FIG. 3 also shows another pattern that later modules in M^{assm} produce features of decreasing similarity with the E2E counterparts over all feature levels. This fading pattern is another manifestation of module compatibility, which may be referred to as the input distribution shift problem. To further analyze this problem, FIG. 4 illustrates the CKA similarity between the input of module

$${M}_{i}^{*}$$

at the end of the modularized training phase (e.g., the firstly training phase 100 with the greedy implementation) and the input or module

$${M}_{i}^{*}$$

at the start of the assembly fine-tuning phase. In FIG. 4, module index is represented by the horizontal axis and the input similarity is represented by the vertical axis. As shown in FIG. 4, the result may clearly demonstrate the increasing input distribution shift problem the later modules are faced with.

In the modularized training phase (e.g., the firstly training phase 100 with the greedy implementation), module Mᵢ receives its input from a feature feeder (e.g., feature feeder 130), while in the assembled model, module

$${M}_{i}^{*}$$

receives its input from its preceding module

$${M}_{i - 1}^{*} .$$

Since no constraint is made between the output of the feature feeder and the output of

$${M}_{i - 1}^{*} ,$$

the input distribution of

$${M}_{i}^{*}$$

shifts. Moreover, do more modules are stacked together, later modules are affected more by the shifted input distribution. That is, stacked modules are producing increasingly incompatible features for later modules.

To solve the problems of compatibility, the proposed method enables some level of module compatibility when modules are being trained in a fully decoupled way, by introducing a lightweight, pre-trained meta network \hat{M}=\hat{M}_{K}·\hat{M}_{K-1}· . . . ·\hat{M}₁, with \hat{M}ᵢ: [symbol] ᵢ₋₁→ [symbol] ᵢ having the same input and output spaces as Mᵢ. In order to train the module Mᵢ in a modularized fashion, the other modules Mⱼ may be replaced by \hat{M}ⱼ (j≠i) in formulation (1), resulting in:

$${h}_{i - 1} = {\hat{M}}_{i - 1} ∘ … ∘ {\hat{M}}_{1} ( x ) , \\ {δ}_{i} = {∇}_{{h}_{i}} L ( {\hat{M}}_{K} ∘ … ∘ {\hat{M}}_{i + 1} ( {h}_{i} ) , y ) \qquad Formulation ( 2 )$$

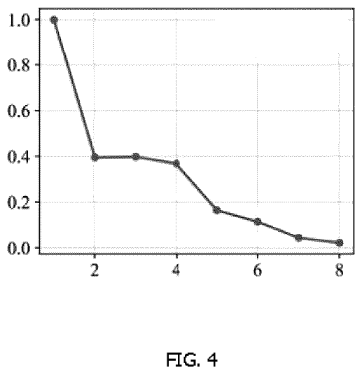

FIG. 5 illustrates an example schematic diagram of a process 520 for modularized training using a meta network 510, according to one or more aspects of the present disclosure.

The process 520 may be performed according to formulation (2). Block 530 denotes a pre-trained module, and circle 560 denotes a loss function. Arrow 540 may represent a forward-propagation, and arrow 550 may represent a back-propagation during the training of the module Mᵢ. Analogously, the process 520 may be considered as a “surrogacy” process, where the meta network 510 may serve as the substitute for the original model M to “incubate” the module Mᵢ. With the meta network incubating the module Mᵢ, compatibility may be achieved even during the training of the module Mᵢ without any cross-module communication.

In one aspect of the present disclosure, the pre-trained meta network (e.g., the meta network 510) may naturally form a ladder of feature levels when it converges on a dataset. By substituting the module Mᵢ to be trained for \hat{M}ᵢ in the meta network (e.g., as shown in the process 520), the feature level of the inserted module Mᵢ can be implicitly specified. Thus, the compatibility may be encouraged by training each module using the meta network to produce a feature with a matched level to its final position in the assembled model. That is, the problem of feature level mismatch can be mitigated, and a level of compatibility may be introduced in the decoupled or independently training process of modules.

In another aspect of the present disclosure, the introduction of the meta network can also enable a capability of module reusing. A single meta network is capable of training different versions of modules with different sizes. The modules trained in this way can be freely reused to assemble with different versions of other modules to obtain a diverse pool of models. For example, suppose m modules of different depths are trained for each stage, then the size of model pool that can be obtained by model assembling is m^{K}. At the same time, the total number of modules that need to be trained is only Km, and each module can be reused m^{K-1} times.

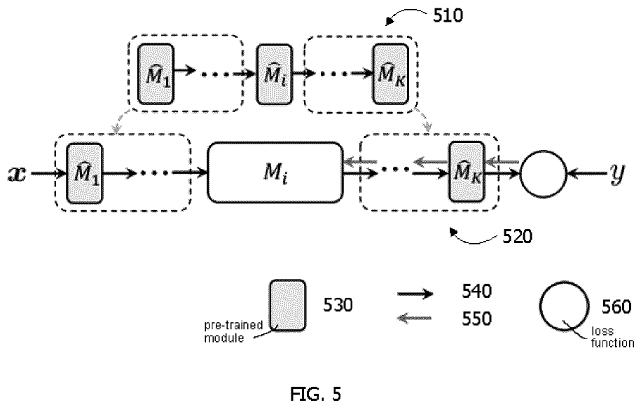

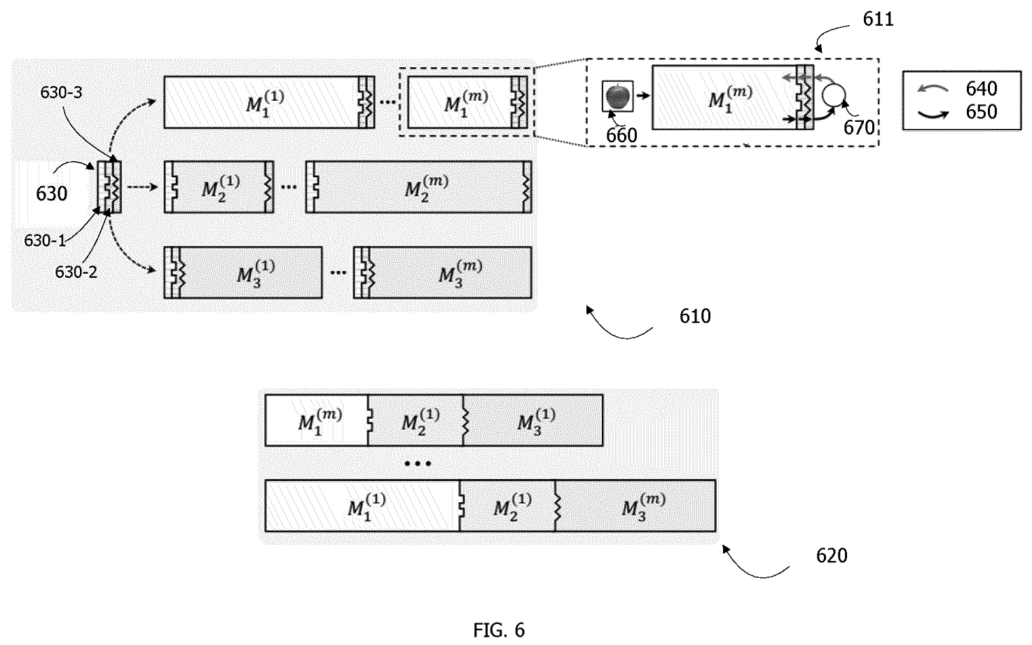

FIG. 6 illustrates an example of module reusing, according to one or more aspects of the present disclosure. In the example of FIG. 6, the meta network 630 may comprise three modules \hat{M}₁ 630-1, \hat{M}₂ 630-2 and \hat{M}₃ 630-3, i.e., K=3, and modules

$${M}_{1}^{( 1 )}$$

to

$${M}_{1}^{( m )}$$

may all be a first module but with different depths, and modules

$${M}_{2}^{( 1 )} to {M}_{2}^{( m )}$$

may all be a second module but with different depths, and modules

$${M}_{3}^{( 1 )} to {M}_{3}^{( m )}$$

may all be a third module but with different depths. In a decoupled training phase 610, each of the modules may be trained in a training process 611, where input 660 may be passed along a direction of forward-propagation 650 and an error signal based on a loss function 670 may be passed along a direction of back-propagation 640 to update parameters of the module that is being trained. In the example of FIG. 6, the total number of modules that need to be trained in the decoupled training phase 610 is 3×m. In a model assembling phase 620, the trained modules may be assembled to form a diverse model pool. Specifically, the assembling may stack the first, second and third modules together to form a whole model, by using one of the trained modules

$${M}_{1}^{( 1 )} to {M}_{1}^{( m )} ,$$

one of the trained modules

$${M}_{2}^{( 1 )} to {M}_{2}^{( m )}$$

and one of the trained modules

$${M}_{3}^{( 1 )} to {M}_{3}^{( m )} ,$$

respectively. In the example of FIG. 6, the size of model pool that can be obtained by the model assembling phase 620 is m³ (i.e., m³ different assembled models). It can be seen that by leveraging the compatibility of modules incubated by the meta network, a diverse pool of assembled models can be obtained with low cost.

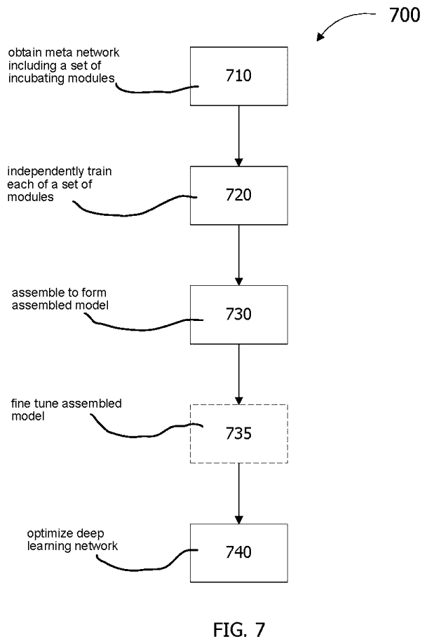

FIG. 7 illustrates an exemplar workflow of a method 700 for modularized training using a meta network to obtain a deep learning network, according to one or more aspects of the present disclosure. The method 700 may be performed according to the process 520, or may be or comprise a part of the process 520, and a dotted block 735 may be an option operation that may be omitted. At block 710, a meta network consisting of a set of incubating modules

$$\hat{M} = {\hat{M}}_{K} ∘ {\hat{M}}_{K - 1} ∘ … ∘ {\hat{M}}_{1}$$

as shown in FIG. 5) may be obtained. Each of the set of incubating modules (e.g., \hat{M}₁, . . . , \hat{M}ᵢ, . . . , \hat{M}_{K}) may comprise at least one basic unit of an architecture of a deep learning network, and the meta network is pre-trained on a dataset. Generally, a deep learning network often starts with an initial processing head followed by a cascade of blocks and then ends with a final task-relevant head. In one aspect of the present disclosure, the basic unit may be a block. For example, the basic unit may be a residual block in ResNet (Residual Networks) or a transformer block in DeiT (Data-efficient image Transformers). Each of the set of incubating modules may comprise as few basic units as possible to enable a lightweight meta network. For example, each of the set of incubating modules may comprise only one basic unit. For another example, the first and the latest incubating module (e. g., \hat{M}₁ and \hat{M}ₖ), in addition to the only one basic unit, may also include the initial processing head and the final task-relevant head, respectively.

At block 720, a set of modules with each of the set of modules corresponding to a respective one of the set of incubating modules may be independently trained on the dataset, by training the meta network with one of the set of incubating modules being substituted by one of the set of modules corresponding to the one of the set of incubating modules on the dataset for training of the one of the set of modules. The number of the set of modules may be equal to the number of the set of incubating modules. The set of modules may be divided from the deep learning network, and the module of the set of modules may comprise more than one basic units of the architecture of the deep learning network. In one aspect of the present disclosure, when we divide a model M into K modules herein, i.e., M=M_{K}·M_{K-1}· . . . ·M₁, the initial processing head and the final task-relevant head are always assigned into M₁ and M_{K}, respectively. All the modules M_{K}, M_{K-1}, . . . Mᵢ, . . . M₂, M₁ may contain the same number of blocks, i.e., evenly dividing the cascade of blocks, or substantially the same in a case that the total number of blocks is not divisible by K. This is not only for simplicity, but also a consideration of efficiency since the blocks in mainstream architectures often have the same computational overhead. Thus, evenly dividing the model can maximally parallelize each decoupled training process. In another aspect of the present disclosure, modules M_{K}, M_{K-1}, . . . Mᵢ, . . . M₂, M₁ may contain different numbers of blocks.

At block 730, the independently trained modules of the set of modules may be assembled to form an assembled model.

At block 740, the deep learning network that is optimized on the dataset may be obtained based at least in part on the assembled model. In one aspect of the present disclosure, the lightweight meta network may train each module of the set of modules with a process like surrogacy, where the meta network may serve as a substitute for the original deep learning network to incubate the module. The compatibility between the set of modules may be encouraged by sharing the meta network, which may implicitly bind the incubated modules together. In this way, the assembled model may not need to be fine-tuned to obtain the deep learning network. The method 700 may obtain the deep learning network directly from the assembled model.

In another aspect of the present disclosure, at block 735, the assembled model may be fine-tuned on the dataset to obtain the deep learning network that is optimized on the dataset. For example, the assembled model may be fine-tuned for a short period of time to improve the compatibility.

In one or more aspects of the present disclosure, each of the set of modules may comprise the same input and output spaces as the respective one of the set of incubating modules. For example, if module Mᵢ of the set of modules contains down-sampling blocks, then these down-sampling blocks must all be preserved in the corresponding incubating module \hat{M}ᵢ. Otherwise, Mᵢ and \hat{M}ᵢ will have different output spaces. This design principle may be formulated as:

$$\#blocks in {\hat{M}}_{i} = max ( \#downsampling blocks in {M}_{i} , 1 ) 1 < i < K \qquad Formulation ( 3 )$$

In other aspects of the present disclosure, the independently training the set of modules may comprise freezing remaining incubating modules of the meta network that are not substituted by the one of the set of modules in the training of the one of the set of modules. For example, in the process 520 of FIG. 5, the remaining incubating modules \hat{M}₁, . . . \hat{M}ᵢ₋₁, \hat{M}ᵢ₊₁, . . . \hat{M}_{K} (i.e., \hat{M}ⱼ(j≠i)) may not be updated during the training of Mᵢ. By freezing the meta network throughout the decoupled training process (e.g., process 520), all modules of the set of modules may be forced to adapt to exactly the same meta network. Thus, an implicit bond may be created between the modules that are trained in this way, which may mitigate the problem of input distribution shift and encourage the module compatibility.

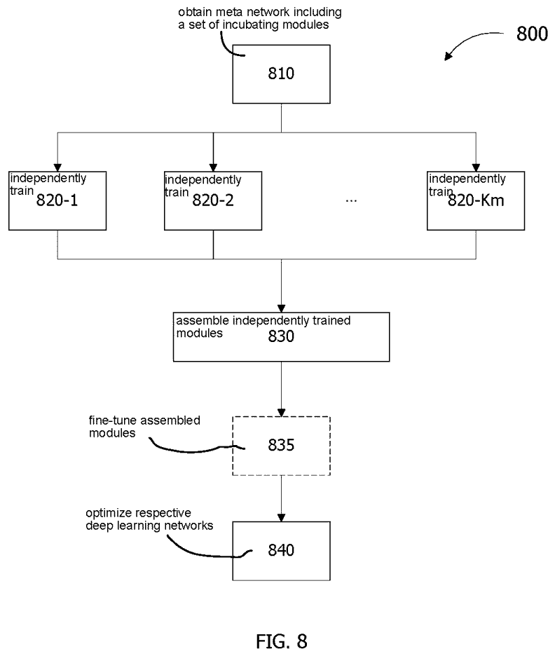

FIG. 8 illustrates an exemplar workflow of a method 800 for module reusing, according to one or more aspects of the present disclosure. The method 800 may be performed according to the decoupled training phase 610 and the model assembling phase 620 of FIG. 6. At block 810, a meta network consisting of a set of incubating modules may be obtained, wherein each of the set of incubating modules comprises at least one basic unit of an architecture of a deep learning network, and the meta network is pre-trained on a dataset. At blocks 820-1 to 820-Km, more than one sets of modules may be independently trained on the dataset. Each module of each set of modules corresponds to a respective one of the set of incubating modules. For example, in the example of FIG. 6, m sets of modules may be trained using the same meta network 630, where a first set of modules may comprise

$${M}_{1}^{( 1 )} , {M}_{2}^{( 1 )} and {M}_{3}^{( 1 )}$$

with

$${M}_{1}^{( 1 )}$$

corresponding to incubating module \hat{M}₁ 630-1,

$${M}_{2}^{( 1 )}$$

corresponding to incubating module \hat{M}₂ 630-2 and

$${M}_{3}^{( 1 )}$$

corresponding to incubating module \hat{M}₃ 630-3, and so on. To train the module

$${M}_{1}^{( m )} ,$$

the meta network may be trained on the dataset with the corresponding \hat{M}₁ 630-1 being replaced by the module

$${M}_{1}^{( m )} ,$$

as shown in the training process 611. For m sets of modules and K modules in each set, totally Km independently training processes may be performed. In one aspect of the present disclosure, a module of one set of modules and a module of another set of modules corresponding to the same incubating module may comprise same input and output spaces but different numbers of basic units. In the example of FIG. 6,

$${M}_{1}^{( 1 )} and {M}_{1}^{( m )}$$

both correspond to incubating module \hat{M}₁ 630-1, but

$${M}_{1}^{( 1 )}$$

may have more layers than

$${M}_{1}^{( m )} .$$

At block 830, the independently trained modules from the more than one sets of modules may be assembled to form different assembled models. In one aspect of the present disclosure, the trained modules may be assembled with each other as long as each module is arranged in the assembled model according to its corresponding position (e.g., in the example of FIG. 6, as

$${M}_{1}^{( m )}$$

is a first module, it should be arranged at the first position in the assembled model). For example, in the example of FIG. 6,

$${M}_{1}^{( m )}$$

from the m^{th} set of modules having a first position,

$${M}_{2}^{( 1 )} and {M}_{3}^{( 1 )}$$

from the first set of modules having a second and third positions may be cascaded in order to form an assembled model, and

$${M}_{1}^{( 1 )} , {M}_{2}^{( 1 )}$$

from the first set of modules having a first and second positions and

$${M}_{3}^{( m )}$$

from the m^{th} set of modules having a third position may be cascaded in order to form another assembled model, as shown by the model assembling phase 620. The size of model pool can be m^{K}, and each trained module can be reused m^{K-1} times.

At optional block 835, the assembled models may be fine-tuned on the dataset to improve compatibility.

At block 840, respective deep learning networks that are optimized on the dataset with different depths may be obtained, based at least in part on the different assembled models.

It should be appreciated that one or more aspects of the present disclosure described with reference to a method and/or process may be combined with other aspects described with reference to other methods and/or process without causing a departure from the present disclosure.

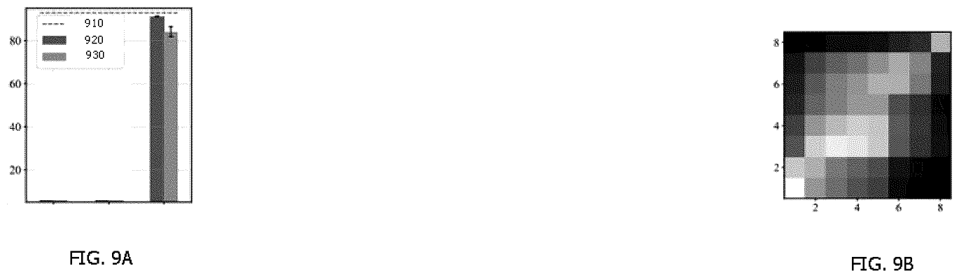

FIG. 9A and FIG. 9B illustrate an experimental performance of the methods 700 and 800 and/or the process 520 with freezing the meta network during the decoupled training phase, according to one or more aspects of the present disclosure. the experiments are conducted using a ResNet-110 with K=8 on CIFAR-10 dataset. In the chart of FIG. 9A, the vertical axis denotes the test accuracy in percentage, and dotted line 910 denotes a testing on E2E, which is also presented as an upper bound. Stripe 930 denotes a testing on the assembled model without fine-tuning, and stripe 920 denotes a testing on the assembled model with fine-tuning. It can be seen from FIG. 9A, though being simple and almost tuning-free, the proposed methods 700 and 800 and/or process 520 can achieve favorable performance compared to E2E training. Moreover, the methods 700 and 800 and/or process 520 can successfully train deep transformer-based models with a large batch size up to 8192 for example, without incurring optimization issues. FIG. 9B illustrates the CKA similarity between the assembled model without fine-tuning and the E2E trained model, all pairs of module output are compared. In FIG. 9B, modules in the assembled model of the methods 700 and 800 and/or process 520 are successively represented along horizontal axis, and modules in E2E trained model M^{E2E} are successively represented along vertical axis. In can be seen from FIG. 9B, the problems of feature level mismatch in early modules and input distribution shift in later modules may be well solved, and the CKA similarity between the assembled model and M^{E2E} may show a healthy pattern.

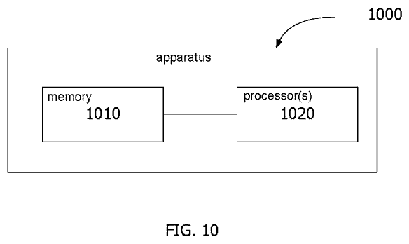

FIG. 10 illustrates an example of a hardware implementation for an apparatus 1000 according to one or more aspects of the present disclosure. The apparatus 1000 for deep learning may comprise a memory 1010 and at least one processor 1020. The processor 1020 may be coupled to the memory 1010 and configured to perform the methods 700, 800 and the process 520 described above with reference to FIG. 7, FIG. 8, and FIG. 5. The processor 1020 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 1010 may store the input data, output data, data generated by processor 1020, and/or instructions executed by processor 1020.

The various operations, models, and networks described in connection with the disclosure herein may be implemented in hardware, software executed by a processor, firmware, a computer or any combination thereof. According one or more aspects of the disclosure, a computer program product for deep learning may comprise processor executable computer code for performing the methods 700, 800 and the process 520 described above with reference to FIG. 7, FIG. 8, and FIG. 5. According to another embodiment of the disclosure, a computer readable medium may store computer code for deep learning, the computer code when executed by a processor may cause the processor to perform the methods 700, 800 and the process 520 described above with reference to FIG. 7, FIG. 8, and FIG. 5. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

In an embodiment of the present disclosure, each of the set of modules may comprise the same input and output spaces as the respective one of the set of incubating modules. A module of the set of modules and a module of the another set of modules corresponding to the same incubating module may comprise the same input and output spaces but different numbers of basic units, e.g., with different layers. For example, in the example of FIG. 6,

$${M}_{1}^{( 1 )} and {M}_{1}^{( m )}$$

both correspond to incubating module \hat{M}₁ 630-1 and have the same input and output spaces as \hat{M}₁ 630-1 (e.g., input or output map size 32×32, 16×16, or 8×8), but

$${M}_{1}^{( 1 )}$$

may have more layers than

$${M}_{1}^{( m )} .$$

In an embodiment of the present disclosure, during the independent training of the set of modules, the remaining incubating modules of the meta network that are not substituted by the one of the set of modules may be frozen. For example, in the process 520 of FIG. 5, the parameters of remaining incubating modules \hat{M}₁, . . . \hat{M}ᵢ₋₁, \hat{M}ᵢ₊₁, . . . \hat{M}_{K} (i.e., \hat{M}ⱼ(j≠i)) may not be updated during the training of Mᵢ.

In an embodiment of the present disclosure, another set of modules with each of the another set of modules corresponding to a respective one of the set of incubating modules may be independently trained on the dataset, by using the meta network. A module of the set of modules and a module of the another set of modules corresponding to the same incubating module may comprise the same input and output spaces, but different numbers of basic units. The independently trained modules from both the set of modules and the another set of modules may be assembled to form another assembled model. Another deep learning network that is optimized on the dataset with a different depth than the deep learning network may be obtained directly from said another assembled model, or by fine-tuning said another assembled model.

In an embodiment of the present disclosure, the apparatus 1000 for deep learning comprising the memory 1010 and at least one processor 1020 may further comprise at least one cache in each of the at least one processor 1020 for storing a meta network. For example, each of the at least one processor 1020 may fetch the meta network from the memory 1010 and write the meta network in its cache. As another example, the at least one processor 1020 may be used to independently train the set of modules with the same meta network stored in the caches, where different modules of the set of modules may be trained simultaneously on separate processors to achieve a parallel computation while using the same meta network to guarantee the compatibility among the different modules. The components of the apparatus 1000 for deep learning may be located in one place, or may be distributed in different locations.

The description above of the disclosed example embodiments of the present invention is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the present invention is not intended to be limited to the embodiments shown herein but is to be accorded the widest scope consistent with the present invention and the principles and novel features disclosed herein.

1-9 (canceled)

10. A computer-implemented method for deep learning, comprising the following steps:
obtaining a meta network including a set of incubating modules, wherein each of the set of incubating modules includes at least one basic unit of an architecture of a deep learning network, and the meta network is pre-trained on a dataset;
independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein each module of the set of modules includes more than one basic units of the architecture of the deep learning network;
assembling the independently trained modules of the set of modules to form an assembled model; and
obtaining, based at least in part on the assembled model, the deep learning network that is optimized on the dataset.

11. The computer-implemented method of claim 10, wherein each of the set of modules includes the same input and output spaces as the respective one of the set of incubating modules.

12. The computer-implemented method of claim 10, further comprising:
fine-tuning the assembled model on the dataset to obtain the deep learning network that is optimized on the dataset.

13. The computer-implemented method of claim 10, wherein the independently training the set of modules further comprises:
freezing remaining incubating modules of the meta network that are not substituted by the one of the set of modules in the training of the one of the set of modules.

14. The computer-implemented method of claim 10, further comprising:
independently training, on the dataset, another set of modules with each of the another set of modules corresponding to a respective one of the set of incubating modules by using the meta network, wherein a module of the set of modules and a module of the another set of modules corresponding to a same incubating module comprise same input and output spaces but different numbers of basic units;
assembling the independently trained modules from both the set of modules and the another set of modules to form another assembled model; and
obtaining, based at least in part on the another assembled model, another deep learning network that is optimized on the dataset with a different depth than the deep learning network.

15. A computer-implemented method of deep learning for a task, comprising the following steps:
obtaining a meta network including a set of incubating modules, wherein each of the set of incubating modules includes at least one basic unit of an architecture of a deep learning network for the task comprising image or speech recognition, and the meta network is pre-trained on a dataset comprising images or speech signals;
independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein module of the set of modules comprises more than one basic units of the architecture of the deep learning network;
assembling the independently trained modules of the set of modules to form an assembled model; and
obtaining, based at least in part on the assembled model, the deep learning network that is optimized on the dataset.

16. An apparatus for deep learning, comprising:
a memory; and
at least one processor coupled to the memory and configured to perform a computer-implemented method for deep learning, including the following steps:
obtaining a meta network including a set of incubating modules, wherein each of the set of incubating modules includes at least one basic unit of an architecture of a deep learning network, and the meta network is pre-trained on a dataset,
independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein each module of the set of modules includes more than one basic units of the architecture of the deep learning network,
assembling the independently trained modules of the set of modules to form an assembled model, and
obtaining, based at least in part on the assembled model, the deep learning network that is optimized on the dataset.

17. A non-transitory computer readable medium on which is stored computer code for deep learning, the computer code when executed by a processor, causing the processor to perform the following steps:
obtaining a meta network including a set of incubating modules, wherein each of the set of incubating modules includes at least one basic unit of an architecture of a deep learning network, and the meta network is pre-trained on a dataset;
independently training, on the dataset, a set of modules with each of the set of modules corresponding to a respective one of the set of incubating modules, by training the meta network with one of the set of incubating modules being substituted by one of the set of modules corresponding to the one of the set of incubating modules on the dataset for training of the one of the set of modules, wherein each module of the set of modules includes more than one basic units of the architecture of the deep learning network;
assembling the independently trained modules of the set of modules to form an assembled model; and
obtaining, based at least in part on the assembled model, the deep learning network that is optimized on the dataset.
